(19) United States
(12) Patent Application Publication
(10) Pub. No.: US 2019/0034884 A1
(43) Pub. Date: Jan. 31, 2019

(54) DATA PROCESSING METHODS AND APPARATUSES

(71) Applicant: ALIBABA GROUP HOLDING LIMITED, George Town (KY)

(72) Inventors: Huaqing SONG, Hangzhou (CN); Tao FANG, Hangzhou (CN); Shiqi LIU, Hangzhou (CN); Ren TANG, Hangzhou (CN); Chuanjun PENG, Hangzhou (CN)

(21) Appl. No.: 16/148,673

(22) Filed: Oct. 1, 2018

Related U.S. Application Data
(63) Continuation of application No. PCT/CN2017/077905, filed on Mar. 23, 2017.

(30) Foreign Application Priority Data
Mar. 31, 2016 (CN) 201610195728.3

(51) Int. Cl. G06Q 10/10; G06Q 10/06

(52) U.S. Cl. CPC G06Q 10/1053; G06Q 10/067

(57) ABSTRACT

The present disclosure provides data processing methods and apparatuses. One exemplary data processing method includes: acquiring interview data about candidates of a set historical period, the interview data of the set historical period including interview data of separate interview rounds, and the interview data of each interview round including a candidate, an interviewer, and an interview result; and evaluating interviewers based on differences of interview results of different interviewers. The present disclosure can automatically use massive historical interview data to evaluate the interview abilities of interviewers. On one hand, the workload of manual evaluation of the interviewers is reduced, thereby reducing the interviewer team management cost of an enterprise. On the other hand, the evaluation of the interview abilities of the interviewers is more objective and accurate, helping the enterprise to choose excellent interviewers and thus improving the interview performance of the enterprise.

### CROSS-REFERENCE TO RELATED APPLICATIONS

The present application claims priority to International Application No. PCT/CN2017/077905, filed on Mar. 23, 2017, which claims priority to and the benefits of Chinese Patent Application No. 201610195728.3, filed on Mar. 31, 2016, both of which are incorporated by reference in their entireties.

### TECHNICAL FIELD

The present disclosure relates to the field of computer technologies, and in particular, to data processing methods and apparatuses.

### BACKGROUND

Talent recruitment is an important and indispensable link in the development of enterprises. In various enterprises, specialized interviewers are usually responsible for interviewing candidates during recruitment. In particular, a large enterprise with great recruitment demand can have a huge interviewer team.

Interviewers' interview abilities vary. At the initial stage of interviews, when the interviewers of a large enterprise are directly faced with massive applications, the interviewers inevitably have some subjective opinions or make erroneous judgments in resume evaluation and first-round interviews. In such cases, it is important to evaluate the interviewability of an interviewer. An excellent interviewer can significantly reduce erroneous judgments and provide interview feedback of great value for reference by other subsequent interviewers, thereby facilitating information exchange and improving efficiency. An unqualified interviewer can cause a vicious circle.

Currently, interview abilities of interviewers are mainly evaluated manually. Interviewers are evaluated and managed based on the subjective opinions of human resource (HR) staff or a manager or based on the statistics of the interviewers' interview results. Such manner for evaluating interviewers has two disadvantages: one is that the evaluation results of the interview abilities of interviewers are too subjective and not sufficiently accurate; the other is that such evaluation on the interview abilities of interviewers requires high manual workload and is inefficient. In particular, when the interviewer team is relatively large, the workload for evaluating the interviewers can be significantly increased, the efficiency for the evaluation can become even lower, and the evaluation performance can be undermined.

### SUMMARY

Embodiments of the present disclosure provide data processing methods and apparatuses, which can make evaluation of interview abilities of interviewers more objective and accurate, thereby helping improve the interview performance of the interviewers.

According to some embodiments of the present disclosure, data processing methods are provided. One exemplary method includes: acquiring interview data of a set historical period, the interview data of the set historical period comprising interview data of separate interview rounds, and the interview data of each interview round comprising a candidate, an interviewer, and an interview result; and evaluating interviewers based on differences of interview results of different interviewers. In some embodiments, evaluating interviewers based on differences of interview results of different interviewers includes determining a relative interview ability level of an interviewer in an interviewer group based on degrees of the differences of the interview results of different interviewers with respect to the same candidate.

According to some embodiments of the present disclosure, data processing apparatuses are provided. One exemplary data processing apparatus includes a memory storing a set of instructions and a processor. The processor is configured to execute the set of instructions to cause the apparatus to perform: acquiring interview data of a set historical period, the interview data of the set historical period comprising interview data of separate interview rounds, and the interview data of each interview round comprising a candidate, an interviewer, and an interview result; and evaluating interviewers based on differences of interview results of different interviewers. In some embodiments, evaluating interviewers based on differences of interview results of different interviewers includes determining a relative interview ability level of an interviewer in an interviewer group based on degrees of the differences of the interview results of different interviewers with respect to the same candidate.

According to some embodiments of the present disclosure, non-transitory computer-readable media that store a set of instructions that is executable by at least one processor of a computer to cause the computer to perform a data processing method. One exemplary method includes: acquiring interview data of a set historical period, the interview data of the set historical period comprising interview data of separate interview rounds, and the interview data of each interview round comprising a candidate, an interviewer, and an interview result; and evaluating interviewers based on differences of interview results of different interviewers. In some embodiments, evaluating interviewers based on differences of interview results of different interviewers includes determining a relative interview ability level of an interviewer in an interviewer group based on degrees of the differences of the interview results of different interviewers with respect to the same candidate.

Exemplary data processing methods according to embodiments of the present disclosure can automatically use massive historical interview data to evaluate interview abilities of interviewers. On one hand, the workload of manual evaluation of the interviewers is reduced, thereby achieving high efficiency and reducing the interviewer team management cost of an enterprise. On the other hand, the evaluation of the interview abilities of the interviewers is more objective and accurate, helping the enterprise to choose excellent interviewers and thus improving the interview results of the enterprise.

Exemplary data processing apparatuses according to embodiments of the present disclosure can automatically use massive historical interview data to evaluate the interview abilities of interviewers. On one hand, the workload of manual evaluation of the interviewers is reduced, thereby achieving high efficiency and reducing the interviewer team management cost of an enterprise. On the other hand, the evaluation of the interview abilities of the interviewers is more objective and accurate, helping the enterprise to choose excellent interviewers and thus improving the interview performance of the enterprise.

### BRIEF DESCRIPTION OF THE DRAWINGS

The accompanying drawings constitute a part of this specification. The drawings illustrate several embodiments of the present disclosure and, together with the description, serve to explain the principles of the disclosed embodiments as set forth in the accompanying claims.

FIG. 1 is a flowchart of an exemplary data processing methods according to some embodiments of the present disclosure.

FIG. 2 is a schematic diagram illustrating exemplary interview data of a candidate according to some embodiments of the present disclosure.

FIG. 3 is a structural block diagram of an exemplary data processing apparatus according to some embodiments of the present disclosure.

### DETAILED DESCRIPTION

The principles and features of the present disclosure are described in further detail below with reference to the accompanying drawings and exemplary embodiments of the present disclosure. The exemplary embodiments are merely used for illustrating the present disclosure and are not intended to limit the scope of the present disclosure. All other embodiments obtained by those of ordinary skill in the art according to the spirit of the present disclosure shall fall within the protection scope of the present disclosure.

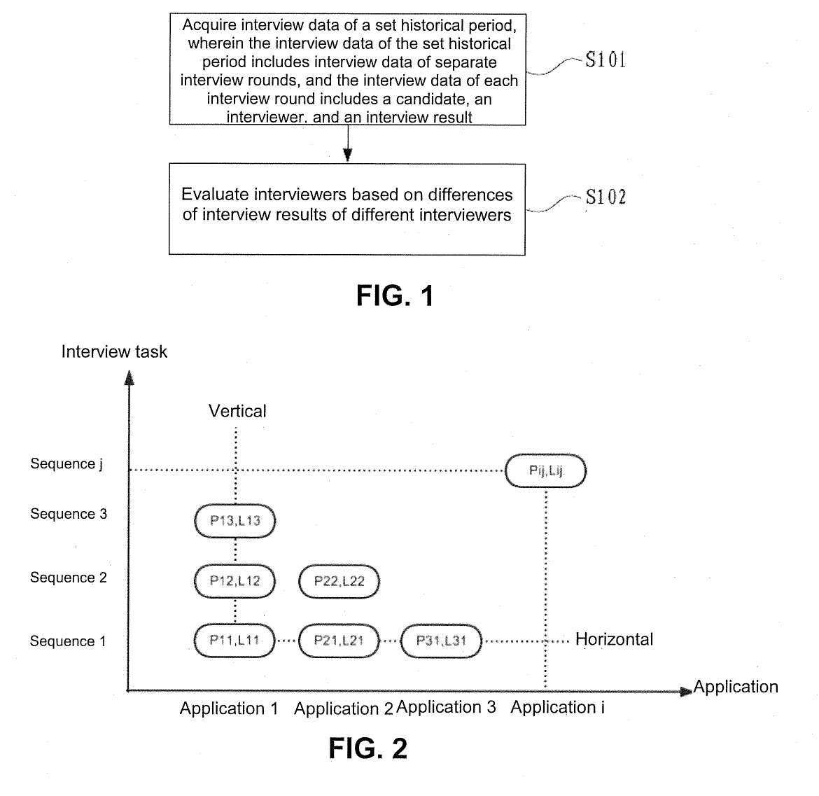

FIG. 1 is a flowchart of an exemplary data processing method according to some embodiments of the present disclosure. As shown in FIG. 1, an exemplary data processing method can include the following procedures.

In step S101, interview data of a set historical period is acquired, the interview data of the set historical period including interview data of separate interview rounds, and the interview data of each interview round including a candidate, an interviewer, and an interview result.

As described herein, the acquired interview data is the interview data collected during a past period of time, for example, interview data of the past one or two years, or interview data of the past several months.

In some embodiments, the interview result can include whether a candidate passes an interview, a rating assigned by an interviewer to the candidate, etc. In one exemplary embodiment, passing an interview can be marked as 1 and failing an interview can be marked as 0. The rating assigned by the interviewer to the candidate can be within a set integer range, for example, an integer from 1 to 5, an integer from 1 to 10, etc.

In step S102, interviewers are evaluated based on differences of interview results of different interviewers.

In some embodiments of the present disclosure, step S102 can include: determining relative interview ability levels of to-be-evaluated interviewers in a particular interviewer group based on degrees of the differences of the interview results of different interviewers with respect to the same candidate.

In some embodiments, the same candidate can refer to one candidate or refer to multiple candidates. In some embodiments, interview results of the interviewers with respect to the same candidates indirectly can also be used for the evaluation.

In some embodiments, the particular interviewer group can include all or some of the interviewers of a company. In some embodiments, the interviewer group in step S102 can include all or some of the interviewers associated with the interview data in step S101.

The degrees of the differences of the interview results represent how much the interview results assigned by different interviewers to the same candidate differ from each other. As a non-limiting example, when one candidate applies for 5 positions of a company, there is only one interviewer in an interview for each position, and there is only one round of interview for each position. It is assumed that among the interviews for the 5 positions, only one interviewer (e.g., interviewer A) gives an interview result of failing the interview, and the other 4 interviewers all give an interview result of passing the interview. In this case, the interview result of the interviewer A differs by a great degree from the interview results of the other interviewers with respect to the same candidate. If 3 interviewers, including interviewer A, give an interview result of failing the interview while the other 2 interviewers give an interview result of passing the interview, the interview result of the interviewer A differs by a small degree from the interview results of other interviewers with respect to the same candidate.

The degrees of the differences of the interview results are generated based on the massive interview data acquired in step S101 rather than being determined only according to interview result of one interview or interview results of a few interviews. In other words, the degrees of the differences of the interview results are conclusions made based on a large number of interview results of numerous interviews, rather than data based on one or a few interviews.

In one exemplary situation, the differences of the interview results of different interviewers can include differences of interview results assigned by different interviewers to the same candidate at the same stage of different applications of the same candidate. In another exemplary situation, the differences of the interview results of different interviewers can include differences of interview results assigned by different interviewers to the same candidate at different stages of the same application of the same candidate. Embodiments of the present disclosure can include these two situations at the same time or can include either of these two situations.

In embodiments of the present disclosure, determining relative interview ability levels of to-be-evaluated interviewers in a particular interviewer group based on degrees of the differences of the interview results of different interviewers with respect to the same candidate can include the following procedures.

In step a, an evaluation score of each interview is calculated according to a set evaluation score model using the interview data, the evaluation score model being based on the degrees of the differences of the interview results of the different interviewers with respect to the same candidate.

Each interview may be scored in step a. Each interview may be scored based on the same standard, such as the same evaluation score model, and a large amount of such scoring results may then be processed subsequently.

In step b, the mean of the evaluation score of a single interview of each interviewer is calculated respectively and is recorded as a first mean of each interviewer.

As a non-limiting example, a total number of interviews of an interviewer can be M, and a sum of the evaluation scores obtained by the interviewer in the M interviews is N. In this case, the first mean of the interviewer is equal to N/M, wherein the symbol “/” represents a division operation.

An evaluation score of an interviewer in one interview is fortuitous. However, the mean of the evaluation scores of many interviews can relatively more accurately reflect the level of the evaluation score of the interviewer in a single interview.

In step c, a ranking score of each interviewer is calculated according to the first mean based on a predetermined ranking score model.

The ranking score is used for evaluating the interview ability of an interviewer. The higher the ranking score is, the stronger the interview ability of the interviewer is. On the contrary, the lower the ranking score is, the poorer the interview ability of the interviewer is.

In step d, the interviewers are ranked according to the ranking scores in a descending order, a position of a to-be-evaluated interviewer in the ranking being the relative interview ability level of the to-be-evaluated interviewer in the interviewer group.

In some embodiments of the present disclosure, step c can include: making the ranking scores of the interviewers equal to the respective first means of the interviewers.

In some embodiments of the present disclosure, step c can include: calculating the mean of the evaluation scores of a single interview of all interviewers associated with the interview data, and recording the mean as a second mean; and obtaining the ranking score of each interviewer according to a weight of the first mean and a weight of the second mean. For example, weighted addition can be performed on the first mean and the second mean, and the result of the weighted addition can be used as the ranking score of the interviewer. As a non-limiting example, the total number of interviews of all the interviewers associated with the interview data is T, and a total of the evaluation scores of the T interviews is Q. In this example, the second mean is equal to Q/T, wherein the symbol “I” represents a division operation. It is recognized that the ranking score obtained by the weighted addition of the first mean and the second mean is more objective and pertinent.

In some embodiments of the present disclosure, obtaining the ranking score of each interviewer according to a weight of the first mean and a weight of the second mean can include: setting the weight of the first mean to be positively correlated to v/(v+m) and the weight of the second mean to be positively correlated to m/(v+m), wherein v is a total number of interviews of a corresponding interviewer associated with the interview data, and m is a preset threshold for the number of interviews. For example, m can be set according to the minimum number of interviews of a predetermined number of interviewers with the highest evaluation scores of a single interview. In other words, the minimum number of interviews of a predetermined number of interviewers with the highest evaluation scores of a single interview can be set as the threshold for the number of interviews.

Exemplary embodiments of the data processing method according to the present disclosure are described in further detail below.

In some embodiments, an interview result can include content of two aspects: one aspect is whether a candidate passes the interview, wherein passing the interview can be marked as 1 and failing the interview can be marked as 0, for example; and the other aspect is a rating assigned by an interviewer to the candidate. FIG. 2 is a schematic diagram illustrating exemplary interview data of a candidate according to some embodiments of the present disclosure.

As shown in FIG. 2, the abscissa Application represents each application, and the ordinate Task represents each round of interview task. In FIG. 2, Pᵢⱼ represents whether the candidate passes the jth round of the interview task of the ith application (e.g., the value of Pij is 0 or 1), and Lij represents a rating given by an interviewer in the jth round of the interview task of the ith application.

In one exemplary embodiment, it is predetermined that the highest evaluation score of a single interview is 5.

In some embodiments, an evaluation score of each interview can be calculated according to a predetermined evaluation score model using the interview data. For example, an evaluation score model can be represented as follows:

S=Max{W_{Horizontal}*S_{Horizontal}+W_{Vertical}*S_{Vertical},5} Formula (1)

wherein W_{Horizontal} and W_{vertical} are weights predetermined according to empirical values, S_{Horizontal} is a horizontal weight calculated according to the following formula (2), and S_{vertical} is a vertical weight calculated according to the following formula (3).

The sum of W_{Horizontal} and W_{vertical} is a fixed value. When the horizontal weight S_{Horizontal} needs to be more emphasized, W_{Horizontal} can be set to be greater than W_{vertical}. When the vertical weight S_{Vertical} needs to be more emphasized, W_{Horizontal} can be set to be less than W_{vertical}.

In some embodiments, the horizontal weight S_{Horizontal} can be calculated using the following formula:

S_{Horizontal}=Max{S_{P1}+S_{L1},5} Formula (2)

When calculating the horizontal weight S_{Horizontal}, j is fixed, wherein
when Pᵢ=1 and Pᵢ₊₁=0, S_{P1}=2;
when Pᵢ=1 and Pᵢ₊₁=1, S_{P1}=4;
when Pᵢ=0, S_{P1}=0;
when Lᵢ=Lᵢ₊₁, S_{L1}=α₁*(Lᵢ+β₁);
when |LᵢLᵢ₊₁|=1, S_{L1}=0, Lᵢ−Lᵢ₊₁| representing an absolute value of a difference between Lᵢ and Lᵢ₊₁; and
when |Lᵢ−Lᵢ₊₁|>1, S_{L1}=−α₂*(|Lᵢ−Lᵢ₊₁|+β₂),
   wherein α₁, β₁, α₂ and β₂ are preset weighting factors, and are positive integers.

In some embodiments, the vertical weight S_{Vertical} can be calculated using the following formula:

S_{Vertical}=Max{S_{P2}+S_{L2},5} Formula (3)

When calculating the vertical weight S_{Vertical}, i is fixed, wherein
when Pⱼ=1 and Pⱼ₊₁=0, S_{P2}=2;
when Pⱼ=1 and Pⱼ₊₁=1 S_{P2}=4;
when Pⱼ=0, S_{P2}=0;
when Lⱼ=Lⱼ₊₁, S_{L2}=α₁*(Lᵢ+β₁);
when |Lⱼ−Lⱼ₊₁|=1, S_{L2}=0, |Lⱼ−Lⱼ₊₁| representing an absolute value of a difference between Lⱼ and Lⱼ₊₁; and
when |Lⱼ−Lⱼ₊₁|>1, S_{L2}=α₂*(|Lⱼ−Lⱼ₋₁|+β₂),
wherein α₁, β₁, α₂, and β₂ are preset weighting factors, and are positive integers.

According to the evaluation score model in this example, if two evaluations are different, the greater the difference between the two evaluations is, the lower the evaluation score can be.

In some embodiments, the mean of the evaluation score of a single interview of each interviewer is calculated respectively and recorded as a first mean of the interviewer. As described herein, R may be used to represent the first mean of a to-be-evaluated interviewer.

In some embodiments, when a total number of interviews of an interviewer is M, and a sum of the evaluation scores obtained by the interviewer in the M interviews is N, the first mean of the interviewer is equal to N/M, wherein the symbol “/” represents a division operation.

In some embodiments, the mean of the evaluation scores of a single interview of all interviewers associated with the interview data is calculated and recorded as a second mean. As described herein, C may be used to represent the second mean.

In some embodiments, when the total number of interviews of all the interviewers associated with the interview data is T, and a total of the evaluation scores of the T interviews is Q, the second mean is equal to Q/T, wherein the symbol “/” represents a division operation.

In some embodiments, weighted addition can be performed on the first mean and the second mean to obtain a ranking score of each interviewer as follows.

For example, a weight of the first mean can be set to v/(v+m) and a weight of the second mean can be set to m/(v+m), wherein v is a total number of interviews of a corresponding single interviewer associated with the interview data, and m is the minimum number of interviews of a predetermined number of interviewers with the highest evaluation scores of a single interview, wherein the ranking of the evaluation score can be obtained based on the S values of the interviewers as calculated using Formula 1.

An exemplary method for calculating the ranking score WR of a to-be-evaluated interviewer can be represented by the following formula:

$$WR = \frac{v}{v + m} * R + \frac{m}{v + m} * C \qquad Formula ( 4 )$$

Therefore, the ranking score of each interviewer can be calculated using formula (1) to formula (4).

The interviewers can be ranked according to the ranking scores in a descending order. The position of a to-be-evaluated interviewer in the ranking may represent a relative interview ability level of the to-be-evaluated interviewer in the interviewer group.

In some embodiments, the interview result may include content of one aspect, e.g., whether a candidate passes the interview. Each candidate can apply for several positions. In some situations, there is one round of interview for each position, and each interview has one interviewer.

In some embodiments, an evaluation score of each interview can be calculated according to a set evaluation score model using the interview data. An exemplary evaluation score model is described as follows.

The evaluation score is equal to a proportion of some interview results to all interview results with respect to the same candidate. For example, one candidate applies for 10 positions, wherein 4 interview results indicate that the candidate fails the interview and 6 interview results indicate that the candidate passes the interview. In this case, an evaluation score of an interviewer giving the interview result of failing the interview is 4/(4+6)=0.4, and an evaluation score of an interviewer giving the interview result of passing the interview is 6/(4+6)=0.6.

A mean of the evaluation score of a single interview of each interviewer can be calculated respectively and recorded as a first mean.

In some embodiments, the first mean of the interviewer can used as a ranking score of the interviewer.

The interviewers can be ranked according to the ranking scores in a descending order, and a position of a to-be-evaluated interviewer in the ranking can represent a relative interview ability level of the to-be-evaluated interviewer in the interviewer group.

Exemplary data processing methods according to embodiments of the present disclosure can automatically use massive historical interview data to evaluate the interview abilities of interviewers. On one hand, the workload of manual evaluation of the interviewers is reduced, thereby achieving high efficiency and reducing the interviewer team management cost of an enterprise. On the other hand, the evaluation of the interview abilities of the interviewers is more objective and accurate, helping the enterprise to choose excellent interviewers and thus improving the interview performance of the enterprise.

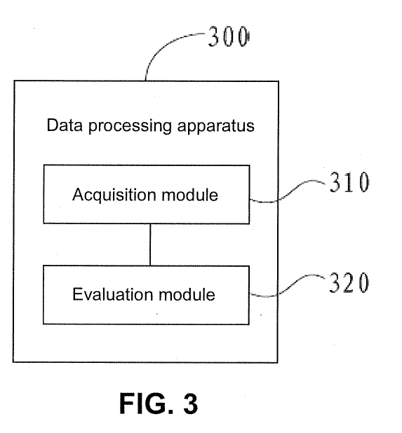

FIG. 3 is a structural block diagram of an exemplary data processing apparatus according to some embodiments of the present disclosure. The exemplary data processing apparatus as shown in FIG. 3 can be used for implementing the exemplary data processing methods described above. The principles of the above-described exemplary data processing methods according to the present disclosure are also applicable to the exemplary data processing apparatuses described below.

As shown in FIG. 3, in some embodiments, an exemplary data processing apparatus 300 can include an acquisition module 310 and an evaluation module 320. The acquisition module 310 can be configured to acquire interview data of a set historical period, wherein the interview data of the set historical period includes interview data of separate interview rounds, and the interview data of each interview round includes a candidate, an interviewer, and an interview result. The evaluation module 320 can be configured to evaluate interviewers based on differences of interview results of different interviewers.

In some embodiments of the present disclosure, the evaluation module 320 can include a determining module. The determining module can be configured to determine a relative interview ability level of a to-be-evaluated interviewer in a particular interviewer group based on degrees of differences of the interview results of different interviewers with respect to the same candidate.

In one situation, the differences of the interview results of different interviewers can include differences of interview results assigned by different interviewers to the same candidate at the same stages of different applications of the same candidate. In another situation, the differences of the interview results differences of different interviewers can also include differences of interview results assigned by different interviewers to the same candidate at different stages of the same application of the same candidate. Embodiment of the present disclosure can be used in these two situations at the same time or can be used in either of the two situations.

In some embodiments of the present disclosure, the determining module can further include an evaluation score calculation module, a first calculation module, a ranking score module, and a ranking module. The evaluation score calculation module can be configured to calculate an evaluation score of each interview according to a set evaluation score model using the interview data, wherein the evaluation score model is based on the degrees of the differences of the interview results of the different interviewers with respect to the same candidate. The first calculation module can configured to calculate a mean of the evaluation score of a single interview of each interviewer respectively and record the mean as a first mean of each interviewer. The ranking score module can be configured to calculate a ranking score of each interviewer according to the first mean of each interviewer based on a set ranking score model. The ranking module can configured to rank the interviewers according to the ranking scores calculated by the ranking score module in a descending order. A position of a to-be-evaluated interviewer in the ranking can be represented by the relative interview ability level of the to-be-evaluated interviewer in the interviewer group.

In some embodiments of the present disclosure, the ranking score module can include a first processing unit. The first processing unit can be configured to make the ranking scores of the interviewers equal to the respective first means of the interviewers.

In some embodiments of the present disclosure, the ranking score module can include a second calculation unit and a second processing unit. The second calculation unit can be configured to calculate a mean of the evaluation scores of all interviewers associated with the interview data, and to record the mean as a second mean. The second processing unit can be configured to obtain the ranking score of each interviewer according to a weight of the first mean calculated by the first calculation module and a weight of the second mean calculated by the second calculation unit. For example, the second processing unit can be configured to perform weighted addition of the first mean and the second mean and use the result of the weighted addition as the ranking score of the interviewer.

In some embodiments of the present disclosure, the second processing unit can include a setting subunit. The setting subunit can be configured to set the weight of the first mean to be positively correlated to v/(v+m) and the weight of the second mean to be positively correlated to m/(v+m), wherein v is a total number of interviews of a corresponding single interviewer associated with the interview data, and m is a preset threshold for the number of interviews.

Exemplary data processing apparatuses according to some embodiments of the present disclosure can automatically use massive historical interview data to evaluate the interview abilities of interviewers. On one hand, the workload of manual evaluation of the interviewers is reduced, thereby achieving high efficiency and reducing the interviewer team management cost of an enterprise. On the other hand, the evaluation of the interview abilities of the interviewers is more objective and accurate, helping the enterprise to choose excellent interviewers and improving the interview perfon lance of the enterprise.

The embodiments described above are merely used for illustrating the technical solutions provided by the present disclosure, and are not intended to limit the present disclosure. Those skilled in the art can make various changes and modifications consistent with the present disclosure. Such modifications shall fall within the protection scope of the present disclosure.

The present disclosure may be described in a general context of computer-executable commands or operations, such as a program module, stored on a computer-readable medium and executed by a computing device or a computing system, including at least one of a microprocessor, a processor, a central processing unit (CPU), a graphical processing unit (GPU), etc. In general, the program module may include routines, procedures, objects, components, data structures, processors, memories, and the like for performing specific tasks or implementing a sequence of steps or operations.

Embodiments of the present disclosure may be embodied as a method, an apparatus, a system, a computer program product, etc. Accordingly, embodiments of the present disclosure may take the form of an entirely hardware embodiment, an entirely software embodiment, or an embodiment combining software and hardware for allowing a specialized device having the described specialized components to perform the functions described above.

Furthermore, embodiments of the present disclosure may take the form of a computer program product embodied in one or more computer-readable storage media that may be used for storing computer-readable program codes. Based on such an understanding, the technical solutions of the present disclosure can be implemented in a form of a software product. The software product can be stored in a non-volatile storage medium (which can be a CD-ROM, a USB flash memory, a mobile hard disk, and the like). The storage medium can include a set of instructions for instructing a computer device (which may be a personal computer, a server, a network device, a mobile device, or the like) or a processor to perform a part of the steps of the methods provided in the embodiments of the present disclosure. The foregoing storage medium may include, for example, any medium that can store a program code, such as a USB flash disk, a removable hard disk, a Read-Only Memory (ROM), a Random-Access Memory (RAM), a magnetic disk, or an optical disc. The storage medium can be a non-transitory computer-readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

It should be noted that, the relational terms such as “first” and “second” are only used to distinguish an entity or operation from another entity or operation, and do necessarily require or imply that any such actual relationship or order exists among these entities or operations. It should be further noted that, as used in this specification and the appended claims, the singular forms “a,” “an,” and “the,” and any singular use of any word, include plural referents unless expressly and unequivocally limited to one referent. As used herein, the terms “include,” “comprise,” and their grammatical variants are intended to be non-limiting, such that recitation of items in a list is not to the exclusion of other like items that can be substituted or added to the listed items. The term “if” may be construed as “at the time of,” “when,” “in response to,” or “in response to determining.”

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

This description and the accompanying drawings that illustrate exemplary embodiments should not be taken as limiting. Various structural, electrical, and operational changes may be made without departing from the scope of this description and the claims, including equivalents. In some instances, well-known structures and techniques have not been shown or described in detail so as not to obscure the disclosure. Similar reference numbers in two or more figures represent the same or similar elements. Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A data processing method, comprising:
acquiring interview data of a set historical period, the interview data of the set historical period comprising interview data of separate interview rounds, and the interview data of each interview round comprising a candidate, an interviewer, and an interview result; and
evaluating interviewers based on differences of interview results of different interviewers, comprising:
determining a relative interview ability level of an interviewer in an interviewer group based on degrees of the differences of the interview results of different interviewers with respect to the same candidate.

2. The data processing method of claim 1, wherein the differences of the interview results of different interviewers comprise:
differences of the interview results assigned by different interviewers to the same candidate at the same stages of different applications of the same candidate, or
differences of the interview results assigned by different interviewers to the same candidate at different stages of the same application of the same candidate.

3. The data processing method of claim 1, wherein determining the relative interview ability level of the interviewer in the interviewer group based on the degrees of the differences of the interview results of the different interviewers with respect to the same candidate comprises:
calculating an evaluation score of each interview according to a set evaluation score model using the interview data, the evaluation score model being based on the degrees of the differences of the interview results of the different interviewers with respect to the same candidate;
calculating a mean of the evaluation score of an interview of each interviewer respectively, and recording the mean as a first mean;
calculating a ranking score of each interviewer according to the first mean and a set ranking score model; and
ranking the interviewers according to the ranking scores in a descending order, a position of an interviewer in the ranking corresponding to the relative interview ability level of the interviewer in the interviewer group.

4. The data processing method of claim 3, wherein calculating the ranking score of an interview of each interviewer based on the first mean and the set ranking score model comprises:
making the ranking scores of the interviewers equal to the respective first means of the interviewers.

5. The data processing method of claim 4, wherein calculating the ranking score of an interview of each interviewer based on the first mean and the set ranking score model comprises:
calculating a mean of the evaluation scores of an interview of all interviewers associated the interview data, and recording the mean as a second mean; and
obtaining the ranking score of each interviewer according to a weight of the first mean and a weight of the second mean.

6. The data processing method of claim 5, wherein obtaining the ranking score of each interviewer according to the weight of the first mean and the weight of the second mean comprises:
setting the weight of the first mean to be positively correlated to v/(v+m) and the weight of the second mean to be positively correlated to m/(v+m), wherein v is a total number of interviews of a corresponding interviewer associated with the interview data, and m is a preset threshold for the number of interviews.

7. The data processing method of claim 6, wherein the preset threshold for the number of interviews is a minimum number of interviews of a predetermined number of interviewers with the highest evaluation scores of an interview.

8. A data processing apparatus, comprising:
a memory storing a set of instructions; and
a processor configured to execute the set of instructions to cause the apparatus to perform:
acquiring interview data of a set historical period, the interview data of the set historical period comprising interview data of separate interview rounds, and the interview data of each interview round comprising a candidate, an interviewer, and an interview result; and
evaluating interviewers based on differences of interview results of different interviewers, comprising:
determining a relative interview ability level of an interviewer in an interviewer group based on degrees of the differences of the interview results of different interviewers with respect to the same candidate.

9. The data processing apparatus of claim 8, wherein the differences of the interview results of different interviewers comprise:
differences of interview results assigned by different interviewers to the same candidate at the same stages of different applications of the same candidate, or
differences of interview results assigned by different interviewers to the same candidate at different stages of the same application of the same candidate.

10. The data processing apparatus of claim 8, wherein determining the relative interview ability level of the interviewer in the interviewer group based on the degrees of the differences of the interview results of the different interviewers with respect to the same candidate comprises:
calculating an evaluation score of each interview according to a set evaluation score model using the interview data, the evaluation score model being based on the degrees of the differences of the interview results of the different interviewers with respect to the same candidate;
calculating a mean of the evaluation score of an interview of each interviewer respectively, and recording the mean as a first mean;
calculating a ranking score of each interviewer according to the first mean and a set ranking score model; and
ranking the interviewers according to the ranking scores in a descending order, a position of an interviewer in the ranking corresponding to the relative interview ability level of the interviewer in the interviewer group.

11. The data processing apparatus of claim 10, calculating the ranking score of an interview of each interviewer based on the first mean and the set ranking score model comprises:
making the ranking scores of the interviewers equal to the respective first means of the interviewers.

12. The data processing apparatus of claim 11, wherein calculating the ranking score of an interview of each interviewer based on the first mean and the set ranking score model comprises:
calculating a mean of the evaluation scores of an interview of all interviewers associated the interview data, and recording the mean as a second mean; and
obtaining the ranking score of each interviewer according to a weight of the first mean and a weight of the second mean.

13. The data processing apparatus of claim 12, wherein obtaining the ranking score of each interviewer according to the weight of the first mean and the weight of the second mean comprises:
setting the weight of the first mean to be positively correlated to v/(v+m) and the weight of the second mean to be positively correlated to m/(v+m), wherein v is a total number of interviews of a corresponding interviewer associated with the interview data, and m is a preset threshold for the number of interviews.

14. The data processing apparatus of claim 13, wherein the preset threshold for the number of interviews is a minimum number of interviews of a predetermined number of interviewers with the highest evaluation scores of an interview.

15. A non-transitory computer-readable medium that stores a set of instructions that is executable by at least one processor of a computer to cause the computer to perform a data processing method, the method comprising:
acquiring interview data of a set historical period, the interview data of the set historical period comprising interview data of separate interview rounds, and the interview data of each interview round comprising a candidate, an interviewer, and an interview result; and
evaluating interviewers based on differences of interview results of different interviewers, comprising:
determining a relative interview ability level of an interviewer in an interviewer group based on degrees of the differences of the interview results of different interviewers with respect to the same candidate.

16. The non-transitory computer-readable medium of claim 15, wherein the differences of the interview results of different interviewers comprise:
differences of the interview results assigned by different interviewers to the same candidate at the same stages of different applications of the same candidate, or
differences of the interview results assigned by different interviewers to the same candidate at different stages of the same application of the same candidate.

17. The non-transitory computer-readable medium of claim 15, wherein determining the relative interview ability level of the interviewer in the interviewer group based on the degrees of the differences of the interview results of the different interviewers with respect to the same candidate comprises:
calculating an evaluation score of each interview according to a set evaluation score model using the interview data, the evaluation score model being based on the degrees of the differences of the interview results of the different interviewers with respect to the same candidate;
calculating a mean of the evaluation score of an interview of each interviewer respectively, and recording the mean as a first mean;
calculating a ranking score of each interviewer according to the first mean and a set ranking score model; and
ranking the interviewers according to the ranking scores in a descending order, a position of an interviewer in the ranking corresponding to the relative interview ability level of the interviewer in the interviewer group.

18. The non-transitory computer-readable medium of claim 17, wherein calculating the ranking score of an interview of each interviewer based on the first mean and the set ranking score model comprises:
making the ranking scores of the interviewers equal to the respective first means of the interviewers.

19. The non-transitory computer-readable medium of claim 18, wherein calculating the ranking score of an interview of each interviewer based on the first mean and the set ranking score model comprises:
calculating a mean of the evaluation scores of an interview of all interviewers associated the interview data, and recording the mean as a second mean; and
obtaining the ranking score of each interviewer according to a weight of the first mean and a weight of the second mean.

20. The non-transitory computer-readable medium of claim 19, wherein obtaining the ranking score of each interviewer according to the weight of the first mean and the weight of the second mean comprises:
setting the weight of the first mean to be positively correlated to v/(v+m) and the weight of the second mean to be positively correlated to m/(v+m), wherein v is a total number of interviews of a corresponding interviewer associated with the interview data, and m is a preset threshold for the number of interviews.
